(19) United States
(12) Patent Application Publication
(10) Pub. No.: US 2013/0128907 A1
(43) Pub. Date: May 23, 2013

(54) Coherent Micro-mixer

(71) Applicant: Optoplex Corporation, Fremont, CA (US)

(72) Inventor: Yung-Chieh Hsieh, San Jose, CA (US)

(73) Assignee: Optoplex Corporation, Fremont, CA (US)

(21) Appl. No.: 13/672,679

(22) Filed: Nov. 8, 2012

Related U.S. Application Data
(60) Provisional application No. 61/557,310, filed on Nov. 8, 2011.

(51) Int. Cl. H01S 3/10

(52) U.S. Cl. CPC H01S 3/10053
USPC 372/29.023

(57) ABSTRACT

A coherent micro-mixer provides a 6-port device having two input ports four output ports. A signal light wave is input into one input port and a reference light wave is input into another input port. The four outputs from the output ports combine to produce interference between the two input light beams, with various relative phase shifts.

This application claims priority Provisional Patent Application Ser. No. 61/557,310, titled “Coherent Micro-Mixer” filed Nov. 8, 2011, incorporated herein by reference.

### BACKGROUND OF THE INVENTION

1. Field of the Invention

The present invention relates to coherent detection, and more specifically, it relates to a low cost, compact, and temperature-insensitive optical hybrid.

2. Description of Related Art

Since the late 1990s, the transport capacities of ultra-long haul and long-haul fiber-optic communication systems have been significantly increased by the introduction of the erbium-doped fibre amplifier (EDFA), dense wavelength division multiplexing (DWDM), dispersion compensation, and forward error correction (FEC) technologies. For fiber-optic communication systems utilizing such technologies, the universal on/off-keying (OOK) modulation format in conjunction with direct detection methods have been sufficient to address data rates up to 10 Gb/s per channel.

In order to economically extend the reach and data capacity beyond such legacy systems and into next-generation networks, several technological advancements must take place, including but not limited to, 1) adoption of a differential phase-shift keying (DPSK) modulation format, as opposed to OOK; 2) developments in optical coherent detection; and 3) progress in adaptive electrical equalization technology. In combination, these technologies will boost a signal's robustness and spectral efficiency against noise and transmission impairments.

Such crucial strides in optical signal technology are no longer theoretical possibilities but are feasible solutions in present-day optical networking technology. The path for an optical coherent system has already been paved by 1) the deployment of phase shift keying modulated systems by Tier-1 network providers; and 2) the increased computational capacity and speed of electronic DSP circuits in receivers, which provides an efficient adaptive electrical equalization solution to the costly and difficult optical phase-lock loop. These advances coupled with a commercially feasible optical hybrid solution would likely give pause to Tier-1 providers and carriers to reassess their earlier rationales for not adopting and implementing an optical coherent detection scheme. Perhaps with such advances, optical networks will begin to realize the benefits already recognized in microwave and RF transmission systems for extending capacity and repeaterless transmission distances through coherent detection.

The commercial feasibility of a coherent system for optical signal transmission was first investigated around 1990 as a means to improve a receiver's sensitivity. In contrast to existing optical direct-detection system technology, an optical coherent detection scheme would detect not only an optical signal's amplitude but phase and polarization as well. With an optical coherent detection system's increased detection capability and spectral efficiency, more data can be transmitted within the same optical bandwidth. More over, because coherent detection allows an optical signal's phase and polarization to be detected and therefore measured and processed, transmission impairments which previously presented challenges to accurate data reception, can, in theory, be mitigated electronically when an optical signal is converted into the electronic domain. However, the technology never gained commercial traction because the implementation and benefits of an optical coherent system could not be realized by existing systems and technologies.

Implementing a coherent detection system in optical networks requires 1) a method to stabilize frequency difference between a transmitter and receiver within close tolerances; 2) the capability to minimize or mitigate frequency chirp or other signal inhibiting noise; and 3) an availability of an “optical mixer” to properly combine the signal and the local amplifying light source in local oscillator (LO). These technologies were not available in the 1990s. A further setback to the adoption and commercialization of an optical coherent system was the introduction of the EDFA, an alternative low cost solution to the sensitivity issue.

Notwithstanding the myriad challenges, an optical coherent system (also referred to as “Coherent Light Wave”) remains a holy grail of sorts to the optical community because of its advantages over traditional detection technologies. Coherent Light Wave provides an increase of receiver sensitivity by 15 to 20 dB compared to incoherent systems, therefore, permitting longer transmission distances (up to an additional 100 km near 1.55 μm in fiber). This enhancement is particularly significant for space based laser communications where a fiber-based solution similar to the EDFA is not available. It is compatible with complex modulation formats such as DPSK or DQPSK. Concurrent detection of a light signal's amplitude, phase and polarization allow more detailed information to be conveyed and extracted, thereby increasing tolerance to network impairments, such as chromatic disposition, and improving system performance. Better rejection of interference from adjacent channels in DWDM systems allows more channels to be packed within the transmission band. Linear transformation of a received, optical signal to an electrical signal can then be analyzed using modern DSP technology and it is suitable for secured communications.

There is a growing economic and technical rationale for adoption of a coherent optical system now. Six-port hybrid devices have been used for microwave and millimeter-wave detection systems since the mid-1990s and are a key component for coherent receivers, in principle, the six-port device consists of linear dividers and combiners interconnected in such a way that four different vectorial additions of a reference signal (LO) and the signal to be detected are obtained. The levels of the four output signals are detected by balanced receivers. By applying suitable baseband signal processing algorithms, the amplitude and phase of the unknown signal can be determined.

For optical coherent detection, a six-port 90° optical hybrid should mix the incoming signal with the four quadratural states associated with the reference signal in the complex-field space. The optical hybrid should then deliver the four light signals to two pairs of balanced detectors. Let S(t) and R denote the two inputs to the optical hybrid and

$$S ( t ) + R exp [ j ( \frac{π}{2} n ) ] ,$$

with n=0, 1, 2 and 3, represent the four outputs from it. Using the PSK modulation and phase-diversity homodyne receiver as an illustration, one can write the following expression for the signal power to be received by the four detectors:

$${P}_{n} ( t ) ∝ {P}_{S} + {P}_{R} + 2 \sqrt{{P}_{S} {P}_{R}} cos [ {θ}_{S} ( t ) + {θ}_{C} ( t ) - \frac{π}{2} n ] , \\ n = 0 , … 3 ;$$

where P_{S} and P_{R} are the signal and reference power, respectively, θ_{S}(t) the signal phase modulation, and θ_{C}(t) the carrier phase relative to the LO phase. With proper subtractions, the two photocurrents fed to the TIA's can be expressed as

I_{BD1}∝\sqrt{P_{S}P_{R}}cos [θ_{S}(t)+θ_{C}(t)];

I_{BD2}∝\sqrt{P_{S}P_{R}}sin [θ_{S}(t)+θ_{C}(t)];

encompassing the amplitude and phase information of the optical signal. Accordingly, the average electrical signal power is amplified by a factor of 4P_{R}/P_{S}. Following this linear transformation the signals are electronically filtered, amplified, digitized and then processed. Compared to a two-port optical hybrid, the additional two outputs have eliminated the intensity fluctuation from the reference source (LO).

An optical coherent receiver requires that the polarization state of the signal and reference beam be the same. This is not a gating item as various schemes or equipment are available to decompose and control the polarization state of the beams before they enter the optical hybrid. Further, certain polarization controllers can be used to provide additional security functionality for optical coherent systems, preventing third parties from tapping information or data streams by implementing polarization scrambling and coding techniques.

For laboratory purposes, a 90° optical hybrid has traditionally been constructed using two 50/50-beam splitters and two beam combiners, plus one 90° phase shifter. These optical hybrids can be implemented using all-fiber or planar waveguide technologies; however, both methods have their respective drawbacks. Both technologies require sophisticated temperature control circuits to sustain precise optical path-length difference in order to maintain an accurate optical phase at the outputs. In addition, fiber-based devices are inherently bulky and are unstable with respect to mechanical shock and vibration; whereas, waveguide-based products suffer from high insertion loss, high polarization dependence and manufacturing yield issues. Waveguide-based products are also not flexible for customization and require substantial capital resources to set up.

Accordingly, a low-cost, temperature insensitive and vibration/shock resistant optical hybrid and method of operating same is desirable and such is provided by the present invention.

### SUMMARY OF THE INVENTION

An embodiment of the present device is composed of six layers and can take a variety of forms. Each layer can be a plane parallel fused silica plate or wafer. The device shown in the figure is a three dimensional device having a substantially square dimension and it third dimension of thickness that extends into the plane of the drawing sheet. This thickness need only be large enough to propagate the beams as discussed below. Each layer has a surface that is in proximity to an adjacent layer, where the surfaces of the two layers that are adjacent form an interface. For coherent detection, it is important to have a 90-degree phase shift between I1 and Q1. The phase shift can be achieved using a local heating. In another embodiment, only five layers are provided and

The relative thickness of the central four layers has a ratio of 2:1:1:2. These thicknesses need to match the separation distance of the two input beams. The skew is an important parameter in coherent detection. It is the delay between two ports due to the difference in the optical path.

Various surfaces and interfaces of the coherent micro-mixer are provided with reflectivity configurations that effectively operate as mirrors or as equivalents to mirrors, or as antireflection (AR) coatings or as equivalents to (AR) coatings, or as beamsplitters or as equivalents to beamsplitters. The physical dimensions of each of the reflectivity configurations are small and need only be at least large enough to perform the intended operation on a beam propagating to that configuration. It can be seen that after propagating through the coherent micro-mixer, and operated upon by the indicated reflectivity configurations the S beam and the L beam are combined into each of the four exiting beams, wherein the beams are referred to as one of Q2=S−jL, Q1=S+jL, I2=S−L or I1=S+L.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1A shows a function diagram for a 90-degree optical hybrid

FIG. 1B conceptually illustrates the operation of a 90-degree optical hybrid.

FIG. 2A shows an embodiment of the invention including a 50/50 un-polarized beam splitter, a folding prism, a beam shifter, a spacer and a phase shifter.

FIG. 2B shows a rotated view of the embodiment of FIG. 2A.

FIG. 3 shows the layers of the embodiment of FIG. 2A.

FIG. 4 shows reflectivity as a function of air-gap for a fused silica prism, with light incident at a 45-degree incident angle, where the solid curve represents P-polarized light and the dashed curve represents S-polarized light.

FIG. 5 illustrates the reflectivity configurations utilized in the present invention.

FIG. 6 illustrates an embodiment without the layer 120 of FIG. 2A and including a metallic coating an surface 124.

FIG. 7 shows an embodiment of the coherent micro-mixer of the present invention.

FIG. 8 shows the two input beams widely separated, and the thickness of the central 4 wafers still maintain the ratio of 2:1:1:2.

### DETAILED DESCRIPTION OF THE INVENTION

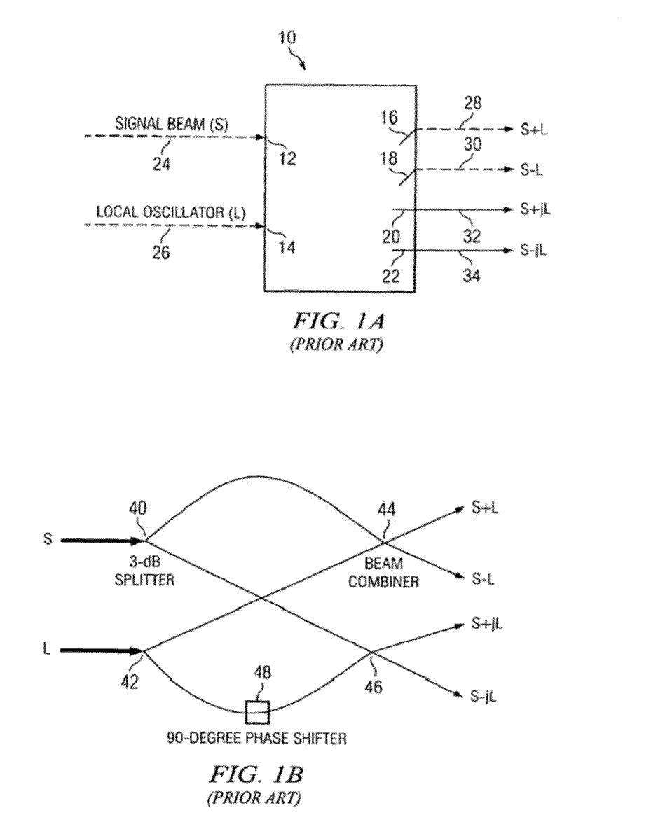

FIG. 1A shows a function diagram for a 90-degree optical hybrid 10. This is a 6-port device in that it has two input ports 12, 14 and four output ports 16, 18, 20 and 22. As shown in FIG. 1A, a signal light wave 24 is input into input port 12 and a reference light wave 26 (from a local oscillator) is input into input port 14. From the four outputs ports 16, 18, 20 and 22 exits four outputs 28, 30, 32 and 34 respectively which are the interferences between the two input light beams, with various relative phase shift.

FIG. 1B conceptually illustrates the operation of a 90-degree optical hybrid. It consists of two 50/50-beam splitters, one each at 40 and 42 and two beam combiners, one each at 44 and 46 plus one 90-degree phase shifter 48. In the practical implementation, this is achieved by waveguide technology. The size is large and it requires temperature control to maintain the required optical path length. In addition to that, typically, the loss is significant and has strong polarization dependence.

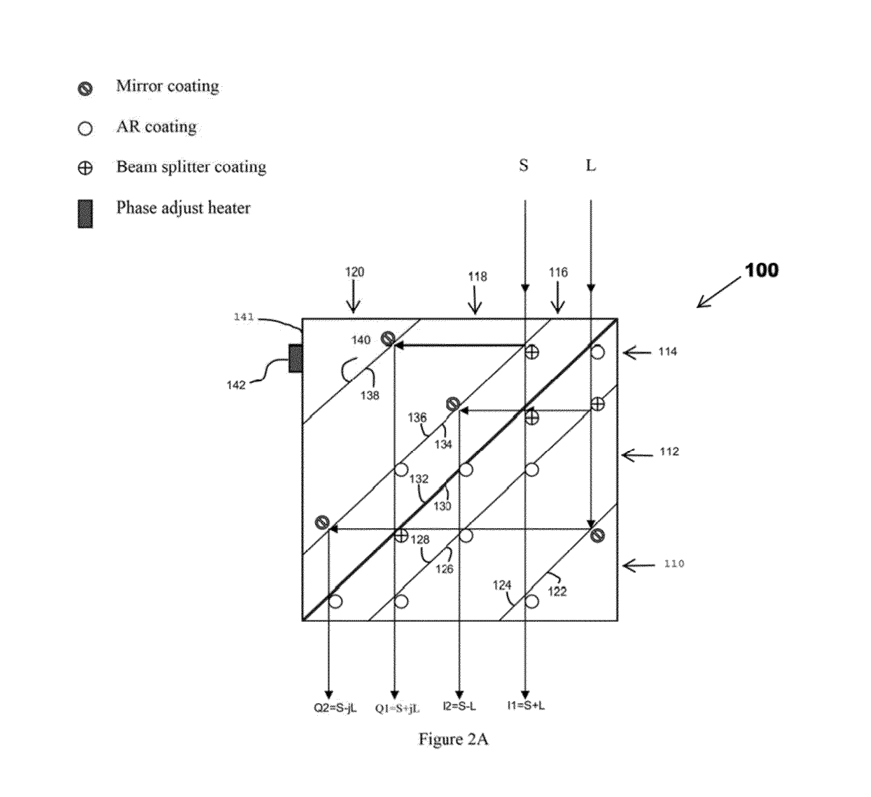

The present invention is an improvement over an earlier optical hybrid design which was taught in U.S. Pat. No. 7,573,641, titled “Free Space Optical Hybrid,” filed Mar. 26, 2007, incorporated herein by reference. FIG. 2A herein shows an exemplary embodiment 100 of the present invention and illustrates a method of its operation. In this embodiment, the device is composed of six layers and can take a variety of forms. Each layer can be a plane parallel fused silica plate or wafer. The device shown in the figure is a three dimensional device having a substantially square dimension and a third dimension of thickness that extends into the plane of the drawing sheet. This thickness need only be large enough to propagate the beams as discussed below. Each layer has a surface that is in proximity to an adjacent layer, where the surfaces of the two layers that are adjacent form an interface. Specifically, the article comprises layers 110, 112, 114, 116, 118 and 120. Layer 110 includes a surface 122. Layer 112 includes surfaces 124 and 126. Layer 114 includes surfaces 128 and 130. Layer 116 includes surfaces 132 and 134. Layer 118 includes surfaces 136 and 138 and layer 120 includes surface 140. A heater is attached to an outer surface 141 of layer 120. For coherent detection, it is important to have a 90-degree phase shift between I1 and Q1. The phase shift can be achieved using a local heating, as shown by the heater 142.

The relative thickness of the layers 112, 114, 116 and 118 has a ratio of 2:1:1:2. These thicknesses need to match the separation distance of the two input beams. For instance, if the separation distance between S and L beams is 250 μm, then the thickness of the layers 112, 114, 116 and 118 is 354 μm, 177 μm, 177 μm and 354 μm, respectively. As a result, the four output beams of beam S overlap and interfere with the corresponding four output beams of beam L. The resulting four output beams are I1, I2, Q1, and Q2 (as shown in FIG. 2A) have an equal spacing of 250 um. Therefore, the four output beams can be easily coupled into commercially available detector arrays, which have a 250 μm pitch.

The skew is an important parameter in the coherent detection. It is the delay between two ports due to the difference in the optical path. The skew of I2, Q1, and Q2, relative to I1 is determined by the optical path length difference. For a 250 μm pitch, relative to I1, the skew of I2, Q1, and Q2 is 1.2 ps, 2.4 ps and 3.6 ps, respectively. These numbers are determined by the design, and can be compensated easily.

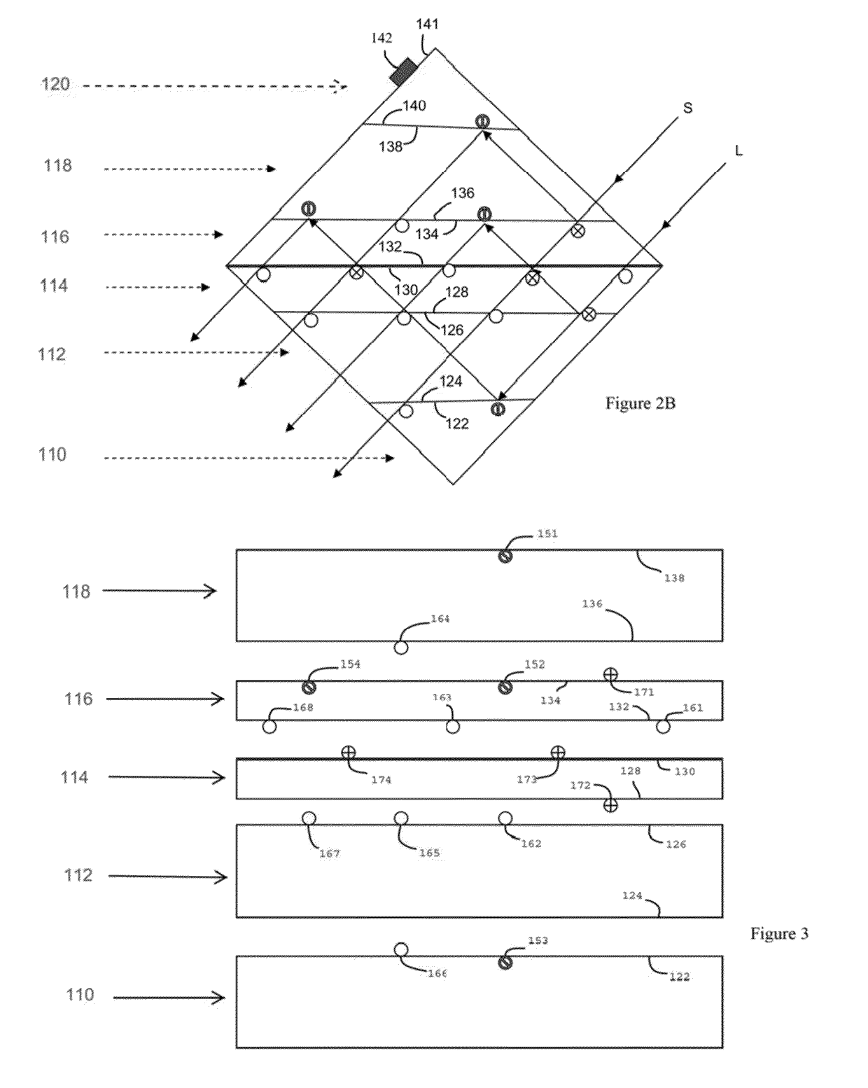

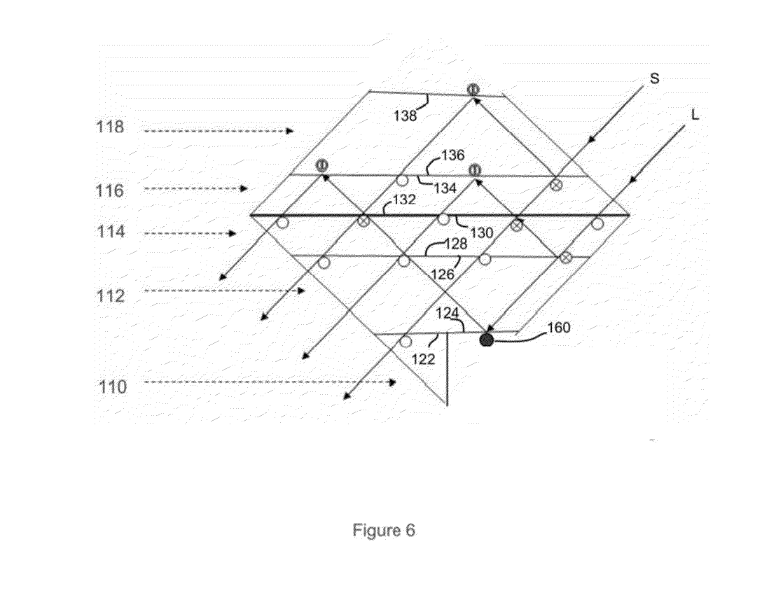

Various surfaces and interfaces of the coherent micro-mixer of FIG. 2A are provided with reflectivity configurations that effectively operate as mirrors or as equivalents to mirrors, or as antireflection (AR) coatings or as equivalents to (AR) coatings, or as beamsplitters or as equivalents to beamsplitters. The particular reflectivity configurations are discussed, e.g., in FIGS. 2A, 2B and 3 and the operation function of each configuration is indicated by the legend of FIG. 2A. Each mirror coating or equivalent is indicated by a circle having a single diagonal line. Each AR coating or equivalent is indicated an unfilled circle. Each beamsplitter or equivalent is indicated by a circle having a cross. The configurations and methods for producing them are shown in FIG. 6 and discussed infra. The operation of this embodiment is further illustrated in FIG. 2A. The physical dimensions of each of the reflectivity configurations are small and need only be at least large enough to perform the intended operation on a beam propagating to that configuration. It can be seen that after propagating through the coherent micro-mixer, and operated upon by the indicated reflectivity configurations the S beam and the L beam are combined into each of the four exiting beams, wherein the beams are referred to as one of Q2=S−jL, Q1=S+jL, I2=S−L or I1=S+L. In FIG. 2B, the embodiment of FIG. 2A is rotated in FIG. 2B to horizontally depict the layers. All reference numbers remain the same as in FIG. 2A.

FIG. 3 illustrates the surface reflectivity configurations of the surfaces of layers 110, 112, 114, 116 and 118. This figure shows the layers separated so that the particular reflectivity configuration of each layer can be discussed. In the fabrication process, the indicated reflectivity configurations are provided on their respective surfaces before they are affixed together and then the micro-mixer is cut to its final shape and then polished. The surface reflectivity configurations are indicated according to the legend of FIG. 2A. Each mirror coating or equivalent is indicated by a circle having a single diagonal line and each is shown with one of reference numbers 151-154. Each AR coating or equivalent is indicated with an unfilled circle and each is shown with one of reference numbers 161-167. Each beamsplitter or equivalent is indicated by a circle having a cross and each is shown with one of reference numbers 171-174. The vertical alignment of the various surface configurations should be noted. Note the alignment of the reflectivity configurations of FIG. 3 with the reflectivity configurations of FIG. 2B. The vertical orientation is provided herein merely for explanation of the alignment of the reflectivity configurations. The AR configurations 161, 163 and 168 of layer 116 do not vertically align with any other reflectivity configurations. Beamsplitter configurations 171 and 172 vertically align. Beamsplitter configuration 173 does not vertically align with any other configuration. Mirror configurations 151-153 and AR configuration 162 are aligned. AR configurations 164-166 are aligned. Beamsplitter configuration 174 does not align with any other configuration. The layers shown in FIG. 3 must be bonded together. In one embodiment, the AR coatings are extended over the layer surface, leaving openings for the mirror and beamsplitter reflectivity configurations.

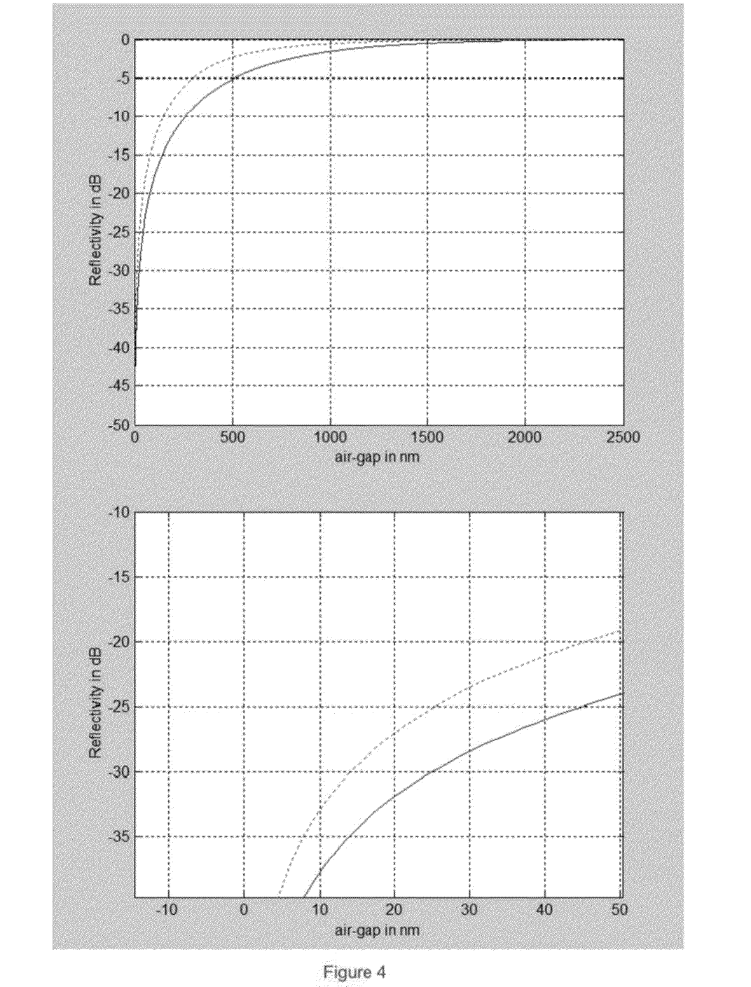

FIG. 4 shows reflectivity, for an internal reflection, as a function of air-gap between a pair of fused silica plates in parallel, with light incident at a 45-degree incident angle, where the solid curve represents P-polarized light and the dashed curve represents S-polarized light. Notice in the graph that when the air-gap is large (2000 nm), the reflectivity is high (near 0 dB). The lower graph shows that when the air-gap is small (50 nm), the reflectivity is low (near −24 dB for P-polarization).

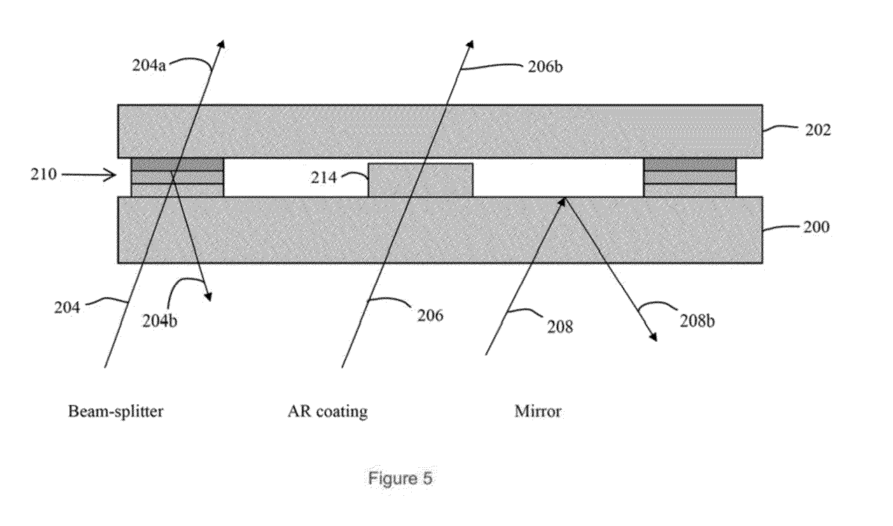

FIG. 5 illustrates some of the reflectivity configurations utilized in the present invention. The air gap between the two glass fused silica) elements 200 and 202 is about 2 μm in this example. There are three exemplary regions provided in the figure. The region on the left side of the figure comprises a beamsplitter coating 210. Methods for fabricating such coatings are known in the art. Notice that the coating touches the two pieces of glass 200 and 202. The beamsplitter can be used to connect two layers together. This area can be used for beam splitting or beam combining. Beam 204 is split by the coating to produce a transmitted beam 204a and a reflected beam 204b. In the center region, a SiO2 coating 214 extends from glass element 200 to almost touch the top glass element 202. If the air-gap is less than 40 nm, more than 99% of the light from bean 206 will pass through the combined glass elements to produce a transmitted beam 206b. In such case, this area effectively operates as an AR coated surface. In the present invention, it is often beneficial if the AR coating touches both surfaces, and can thus be used as a bonding mechanism between two layers. Both the beamsplitter coating and the AR coating can be extended to cover enough area between the two layers in order to provide a stable connection. Care must be given, in the case of the beamsplitter, that its surface area does not inadvertently intersect a beam line. As illustrated with beam 208, where the air-gap is about 2 μm or greater, more than 97% of light will be reflected to form beam 208b. It can be considered as mirror. Those skilled in the art will recognize that the beamsplitter coating and the AR coating can be lithographically produced. This figure shows an interface between two wafers having two BS coatings, and one AR coating. Obviously, the AR coating can be coated on one wafer, and the BS coating on the other. Both AR and BS coatings have about the same thickness. After coating, the two wafers are bonded with optical contact means. It should be noted that even if the AR thickness is slightly less than that of BS coating, the reflectivity at AR coating is still very small (e.g., −30 dB), as explained above. The open space that has no coating can serve as HR or TIR coating.

FIG. 6 illustrates an embodiment that represents a modification of the embodiment of FIG. 2A. Like elements are labeled with identical reference numbers. This embodiment differs from the embodiment of FIG. 2A, except that (i) it lacks layer 120, (ii) it lacks a portion of layer 110 and (iii) it replaces the mirror coating at the interface between surfaces 122 and 124 with a mirror coating 160 (e.g., a metallic coating) on surface 124.

As it is well known, the phase change on reflection by total internal reflection (TIR) is sensitive to the angle of incidence (AOI). If each of the two interference beams experience TIR in its path, due to the symmetry in the design, the angular dependence of the phase change on reflection is cancelled. On the other hand, if only one of the two beams has one more TIR in its path than the other beam has, the phase difference between the two beams will change with the AOI. Again, this embodiment lacks the heater of FIG. 2A and replaces the TIR coating on surface 124 with a metallic coating. Therefore, by tilting the device, the phase difference can be adjusted between I1 and Q1 to satisfy the 90-degree phase shift requirement. Because I1 and I2 are 180 degree out of phase (which is true also for Q1 and Q2), the phase difference between I2 and Q2 is automatically equal to 90 degree approximately, when the phase difference between I1 and Q1 is adjusted to satisfy the 90-degree requirement.

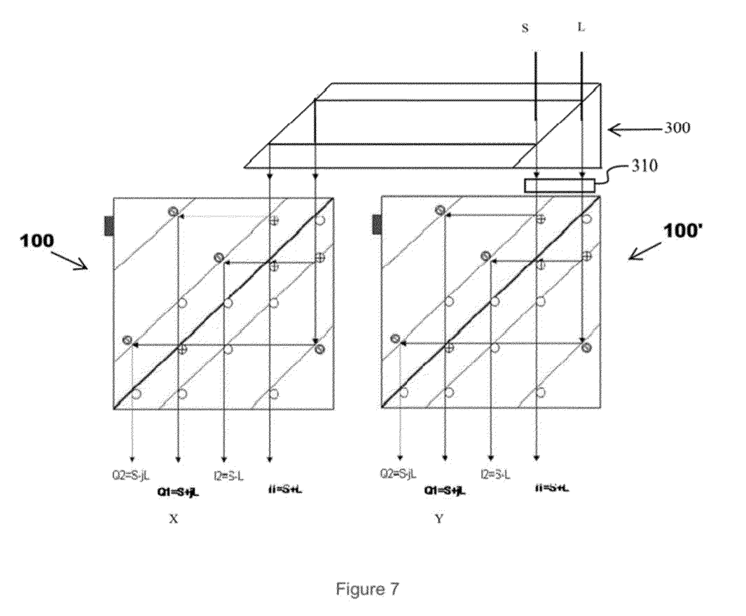

FIG. 7 shows a demodulator having two coherent micro-mixers 100 and 100′. Micro-mixer 100 is the embodiment of FIG. 2A and micro-mixer 100′ is a duplicate of micro-mixer 100. The demodulator further includes a polarizing beamsplitter 300 and a wave plate 310 for the demodulation of DP-QPSK signals.

It should be noted that the phase change on reflection for TIR inside an uncoated glass substrate is dependent not only on AOI, but also on the polarization. Similarly, the phase change by a BS coating is also dependent on the polarization. Therefore, in FIGS. 2A, 2B and 6, the two input beams should have the same polarization. Preferably, the polarization at the input port is either P-polarization (parallel to the plane of the page) or S-polarization (perpendicular to the plane of the page).

In the Dual-Polarization Quadrature Phase Shift Keying (DP-QPSK) demodulation, the signal beam has dual polarizations. The local oscillator beam is orientated accordingly. Therefore, a polarization beam splitter (PBS) is used to separate the polarizations, and a waveplate is used to rotate one of the polarization, as shown in FIG. 7. The polarization of the transmitted beams after the PBS is rotated by the waveplate 310.

It should be also noted that a glass substrate can be coated such that the phase change on reflection for the TIR is only dependent on AOI, but not on the polarization. Similarly, a BS can be made to be non-polarization dependent See U.S. Pat. No. 7,145,727 incorporated herein by reference. Using the special TIR coating and BS coating, the waveplate is not needed.

Finally, due to the highly symmetric structure of the current invention, the device is athermal. The skew among the four exit beams is not sensitive to the environment temperature. The heater in FIG. 2A is used as a phase shifter if the skew between I1 and Q2 needs to be adjusted.

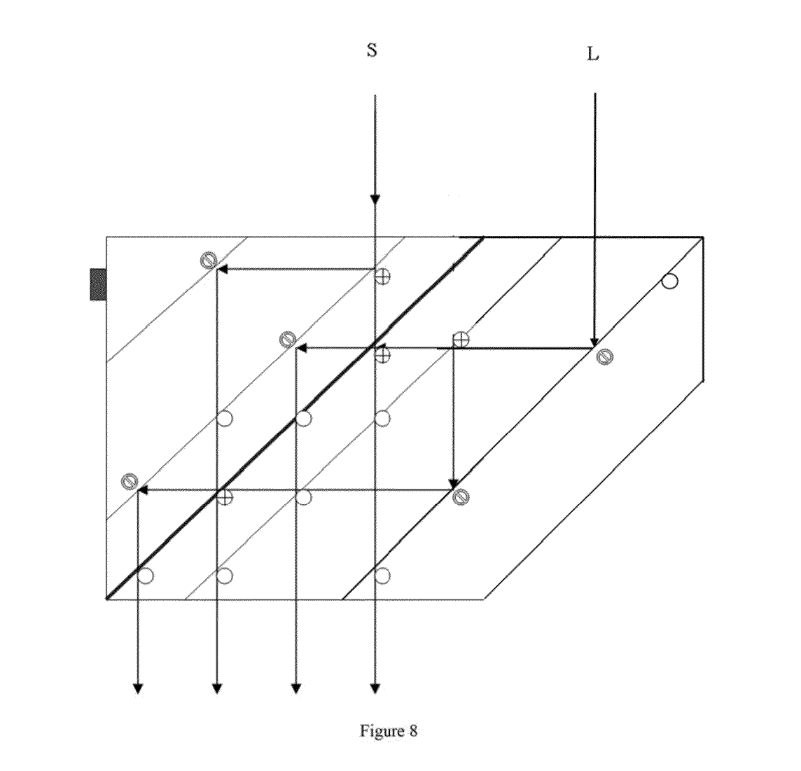

The invention is not limited to the disclosed configurations. Various configurations can be made to have the functionality of the current invention. For example, FIG. 8 shows an embodiment where the two input beams are widely separated, and the thickness of the central 4 wafers still maintain the ratio of 2:1:1:2. In this case, the input beam L is first reflected by either a TIR or metallic coating.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A coherent micro-mixer, comprising:
a first input port for receiving a first beam of light (S beam) into said micro-mixer;
a second input port for receiving a second beam of light (L beam) into said micro-mixer;
a first interface, a second interface, a third interface, a fourth interface and a fifth interface,
wherein said S beam can partially transmit through said first interface and said second interface and then exit said micro-mixer at a first output port,
wherein said S beam can partially reflect at said second interface and then be reflected at said first interface to then exit said micro-mixer at a second output port,
wherein said S beam can partially reflect from said first interface and then be reflected by said fifth interface and then partially transmit through said second interface and then exit said micro-mixer at a third output port,
wherein said S beam can be partially reflected from said first interface, and then be partially reflected by said second interface and then exit said micro-mixer at said fourth output port,
wherein said L beam can partially reflect from said third interface and then partially reflect from said second interface and the exit said micro-mixer at said first output port, wherein said S beam and said L beam are combined to produce a combined beam I1,
wherein said L beam can be reflected at said first interface and then exit said micro-mixer at said second output port, wherein said S beam and said L beam are combined to produce a combined beam I2,
wherein said L beam can be reflected at said fourth interface and then be partially reflected at said second interface and then exit said micro-mixer at said third output port, wherein said S beam and said L beam are combined to produce a combined beam Q1,
wherein said L beam can be reflected at said first interface and then exit said micro-mixer at said fourth output port, wherein said S beam and said L beam are combined to produce a combined beam Q2,
a phase shifter for producing a phase difference between I1 and Q1 of about 90 degrees and a phase difference between I1 and Q2 of about 270 degrees.

2. The coherent micro-mixer of claim 1, wherein said phase shifter comprises a heater.

3. The coherent micro-mixer of claim 1, wherein said phase shifter comprises a metallic reflector operatively positioned at said fourth interface to reflect said L beam.

4. A coherent micro-mixer, comprising:
a first input port for receiving a first beam of light (S beam) into said micro-mixer;
a second input port for receiving a second beam of light (L beam) into said micro-mixer;
means for combining said S beam and said L beam into four combined beams I1, I2, Q1 and Q2, wherein I1 and I2 have a phase difference of about 180 degrees; and
a phase shifter for producing a phase difference between I1 and Q1 of about 90 degrees and a phase difference between I1 and Q2 of about 270 degrees.

5. The coherent micro-mixer of claim 4, wherein said phase shifter comprises a heater.

6. The coherent micro-mixer of claim 4, wherein said phase shifter comprises a metallic reflector operatively positioned at said fourth interface to reflect said L beam.

7. A method for fabricating a coherent micro-mixer, comprising:
providing a first input port for receiving a first beam of light (S beam) into said micro-mixer;
providing a second input port for receiving a second beam of light (L beam) into said micro-mixer;
providing a first interface, a second interface, a third interface, a fourth interface and a fifth interface,
wherein said S beam can partially transmit through said first interface and said second interface and then exit said micro-mixer at a first output port,
wherein said S beam can partially reflect at said second interface and then be reflected at said first interface to then exit said micro-mixer at a second output port,
wherein said S beam can partially reflect from said first interface and then be reflected by said fifth interface and then partially transmit through said second interface and then exit said micro-mixer at a third output port,
wherein said S beam can be partially reflected from said first interface, and then be partially reflected by said second interface and then exit said micro-mixer at said fourth output port,
wherein said L beam can partially reflect from said third interface and then partially reflect from said second interface and the exit said micro-mixer at said first output port, wherein said S beam and said L beam are combined to produce a combined beam I1,
wherein said L beam can be reflected at said first interface and then exit said micro-mixer at said second output port, wherein said S beam and said L beam are combined to produce a combined beam I2,
wherein said L beam can be reflected at said fourth interface and then be partially reflected at said second interface and then exit said micro-mixer at said third output port, wherein said S beam and said L beam are combined to produce a combined beam Q1,
wherein said L beam can be reflected at said first interface and then exit said micro-mixer at said fourth output port, wherein said S beam and said L beam are combined to produce a combined beam Q2,
providing a phase shifter for producing a phase difference between I1 and Q1 of about 90 degrees and a phase difference between I1 and Q2 of about 270 degrees.

8. The method of claim 7, wherein said phase shifter comprises a heater.

9. The method of claim 7, wherein said phase shifter comprises a metallic reflector operatively positioned at said fourth interface to reflect said L beam.

10. A method for fabricating a coherent micro-mixer, comprising:
providing a first input port for receiving a first beam of light (S beam) into said micro-mixer;
providing a second input port for receiving a second beam of light (L beam) into said micro-mixer;
providing means for combining said S beam and said L beam into four combined beams I1, I2, Q1 and Q2, wherein I1 and I2 have a phase difference of about 180 degrees; and
providing a phase shifter for producing a phase difference between I1 and Q1 of about 90 degrees and a phase difference between I1 and Q2 of about 270 degrees.

11. The method of claim 10, wherein said phase shifter comprises a heater.

12. The method of claim 10, wherein said phase shifter comprises a metallic reflector operatively positioned at said fourth interface to reflect said L beam.
